(19) United States
(12) Patent Application Publication
(10) Pub. No.: US 2017/0323243 A1
(43) Pub. Date: Nov. 9, 2017

(54) SYSTEMS AND METHODS FOR MANAGING A MENTORSHIP PROGRAM

(71) Applicant: Center for Autism and Related Disorders, Woodland Hills, CA (US)

(72) Inventor: Cecilia Knight, Spartanburg, SC (US)

(21) Appl. No.: 15/148,953

(22) Filed: May 6, 2016

(51) Int. Cl. G06Q 10/06; G06Q 10/10

(52) U.S. Cl. CPC G06Q 10/06393; G06Q 10/063114; G06Q 10/1097

(57) ABSTRACT

Managing a mentorship program for both mentors and mentees involved with the board certified behavior analyst (BCBA) and a board certified assistant behavior analyst (BCaBA) accreditation programs may involve receiving a selection of a BCBA and a BCaBA accreditation type and/or experience level may be received from a mentee. A set of mentorship goals and tasks to be completed by the mentee may be established. The mentorship goals and tasks may be compliant with a BCBA and/or BCaBA accreditation program.

### FIELD OF INVENTION

The present invention relates to the field of mentorship management and, more particularly, to managing mentorships that occur within a board certified behavior analyst (BCBA) and/or a board certified assistant behavior analyst (BCaBA) accreditation program.

### BACKGROUND

Achieving certification as board certified behavior analyst (BCBA) or a board certified assistant behavior analyst (BCaBA) requires rigorous participation in complex mentorship and other supervised activities. Keeping track of compliance with all mentorship participation standards and requirements presents a challenge to both mentors, who are responsible for overseeing the progress of individuals through the requirements of the BCBA and BCaBA programs and providing mentorship opportunities, as well as mentees or accreditation program participants.

### SUMMARY

Disclosed herein are systems and methods for managing a mentorship program for both mentors and mentees involved with the board certified behavior analyst (BCBA) and a board certified assistant behavior analyst (BCaBA) accreditation programs. In one embodiment, a selection of a BCBA and a BCaBA accreditation type and/or experience level may be received from a mentee. A set of mentorship goals and tasks to be completed by the mentee may then be established. The mentorship goals and tasks may be compliant with a BCBA and/or BCaBA accreditation program. Each of mentorship goals and tasks may be associated with a set of completion criteria and a mastery date. An assignment may then be received from a mentor and it may be determined how the assignment is associated with the mentorship goals and tasks and associated sets of completion criteria. The assignment may then be provided to the mentee and, typically at a subsequent time, an indication that the mentee completed an assignment may be received. The set of mentorship goals and tasks and associated sets of completion criteria may then be updated to reflect the completed assignment and the updated set of mentorship goals and tasks and associated sets of completion criteria may be provided to the mentee.

In one embodiment, information regarding one or more contacts for the mentee may be received and information regarding the contact may be provided to the mentee via a contacts page displayed to the mentee by a display device. In some embodiments, a calendar may be provided to the mentee. The calendar may include one or more appointments associated with a date on the calendar and the appointment may relate to at least one of the goals.

In some cases, a mentee may be provided with a status indicators indicating a status for an assignment, goals, tasks, and/or associated sets of completion criteria. In one embodiment, a personalized supervision form may be generated for the mentee. The personalized supervision form may include information regarding a completion status of the mentee with regard to the set of mentorship goals and tasks and associated sets of completion criteria.

### BRIEF DESCRIPTION OF THE DRAWINGS

The present application is illustrated by way of example, and not limitation, in the figures of the accompanying drawings, in which:

FIG. 1 depicts an exemplary site map for a mentor, consistent with some embodiments of the present invention;

FIG. 2A depicts an exemplary add a new appointment form, consistent with some embodiments of the present invention;

FIG. 2B depicts an exemplary evaluation of supervisee performance form, consistent with some embodiments of the present invention;

FIG. 3 depicts an exemplary site map for a mentee, consistent with some embodiments of the present invention;

FIGS. 4 depicts an exemplary weekly hours graph, consistent with some embodiments of the present invention;

FIG. 5 depicts an exemplary total hours graph, consistent with some embodiments of the present invention;

FIG. 6 depicts an exemplary add a new appointment form, consistent with some embodiments of the present invention; and

FIGS. 7A and 7B depict exemplary BCBA experience supervision forms, consistent with some embodiments of the present invention.

Throughout the drawings, the same reference numerals and characters, unless otherwise stated, are used to denote like features, elements, support structures, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

Described herein is are systems and methods for managing a mentorship program for both mentors and mentees involved with the board certified behavior analyst (BCBA) and a board certified assistant behavior analyst (BCaBA) accreditation programs. The systems and methods described herein are designed to help facilitate the increasing demand for mentorship these programs and to ensure that stringent mentorship requirements are being appropriately met. Those pursuing a BCBA or BCaBA certification have to make their mentorship meaningful and effective while minimizing unnecessary administrative time and the present invention provides a cutting edge solution offering BCBAs a creative platform to make supervision more effective for registered behavior technicians (RBI), BCaBAs, and those pursuing their BCaBA and BCBA certification.

The subject invention may be configured to assist both mentors and mentees with managing and coordinating one or more mentorship opportunities. In some instances, mentors may be Board Certified Behavior Analysts who are mentoring individuals (mentees) who are pursuing their BCaBA and/or BCBA accreditation and/or mentoring RBTs, BCBAs, and/or BCaBAs that are maintaining their respective certification(s).

Mentorship Manager is configured to enable mentors to connect with mentees at the group and/or individual level; track all individual and group mentorship meetings via a calendar; track mentee progress with regard to various requirements via, for example, goal setting features which will be explained in more detail below, progress graphs; organize mentorship meetings with pre-populated supervision forms; share mentorship responsibilities with other mentors who may, or may not, share a particular mentee; upload to a central data source; share documents, videos, quizzes, and/or graphs with mentee(s) and/or other mentors; and save supervision forms in the system for later review and/or signature via, for example, EchoSign.

With the subject invention, mentees who are attempting to, for example, obtain or maintain their certification as RBTs, BCaBA, and BCBA. For mentees pursuing obtaining a BCaBA or BCBA accreditation progress toward various goals (e.g., the goal of earning enough hours to sit for the BCaBA exam or the BCBA exam) may be tracked; mentorship activities with a mentor or mentors may be coordinated in either a group or individual setting; and documents and videos may be uploaded to a central data source for viewing and/or downloading by a mentor or mentors. Accredited/registered behavior technicians and board certified assistant behavior analysts may also be able to track various metrics, such as hours spent doing various tasks and hours spent with a mentor and/or mentee and access, edit, save, and sign various forms using the subject invention.

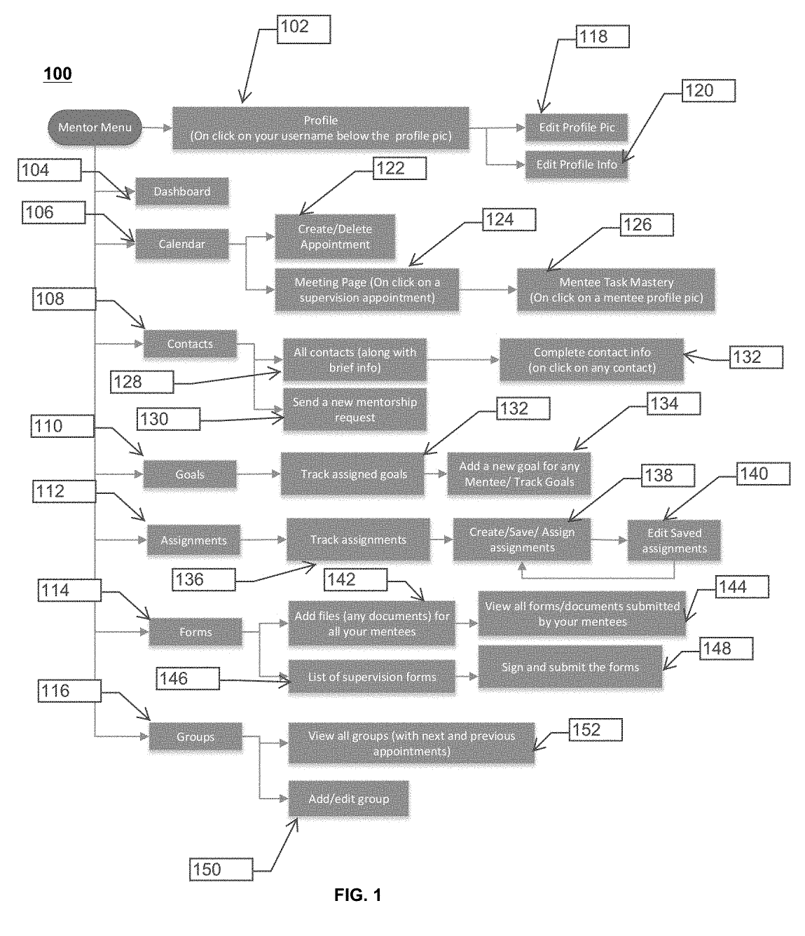

A site map 100 of the subject invention for mentors is provided in FIG. 1, which illustrates the eight primary menu options for a mentor's use of the subject invention. Each of the menu options of site map 100 relate to mentor menu items, buttons, or options, the selection of which may initiate display of a particular page and/or a window within a page on a display device, such as a desktop computer, a laptop computer, a smart phone, and/or tablet computer. The eight primary menu options for site map 100 are profile 102, dashboard 104, calendar 106, contacts 108, goals 110, assignments 112, forms 114, and groups 116.

A mentor may enter profile information (e.g., name, certifications, location, photograph, etc.) and/or create an account via a page and/or window that is displayed following selection of profile menu option 102. The mentor may also edit his or her profile and/or account by selection of an edit profile information option 120 and/or an edit profile picture option 118. In some embodiments, information entered into a mentor's profile page may be viewable by one or more of the mentor's contacts (as managed via the contacts menu 108).

A mentor may access and/or edit a wide range of information about mentorships he or she is involved with via selection of the dashboard option 104, which causes a dashboard page and/or window to be provided to a display device for viewing by the mentor. Exemplary information that may be displayed via a dashboard page includes, but is not limited to, information regarding how many hours are being spent by the mentor and/or mentees on mentorships (e.g., via a chart or graph), statistics on the number of mentees and/or mentee groups established, reminders of appointments or other due dates, reminders, and alerts. Alerts may be categorized according to, for example, time sensitivity and/or priority and this characterization may be manifested in the appearance of the alert of the dashboard screen. For example, highly time sensitive or urgent alerts may be displayed with a red indicator and somewhat less time sensitive or non-urgent alerts may be displayed with a yellow indicator. In some embodiments, red alerts may appear on the dashboard 104 when, for example, a mentee submits a supervision form for the mentor to sign, one of the goals created by the mentor have crossed a deadline and are not yet marked done, and/or an assignment created by the mentor is not yet submitted by some mentee(s) and the deadline has passed. In some embodiments, yellow alerts may appear on the dashboard 104 as, for example, a reminder for a deadline or when a document or other requirement for a mentee has not been submitted on time.

Notifications may also appear on the dashboard 104 in, for example, a portion of a window (e.g., a corner) displaying the dashboard 104. A mentor may interact with a notification by clicking on it so as to, for example, snooze the notification so that it will reappear on the dashboard at a later time and/or when the dashboard 104 is reopened. Notifications may serve to alert a mentor that, for example, an appointment with the mentor has been scheduled, requested, and/or cancelled.

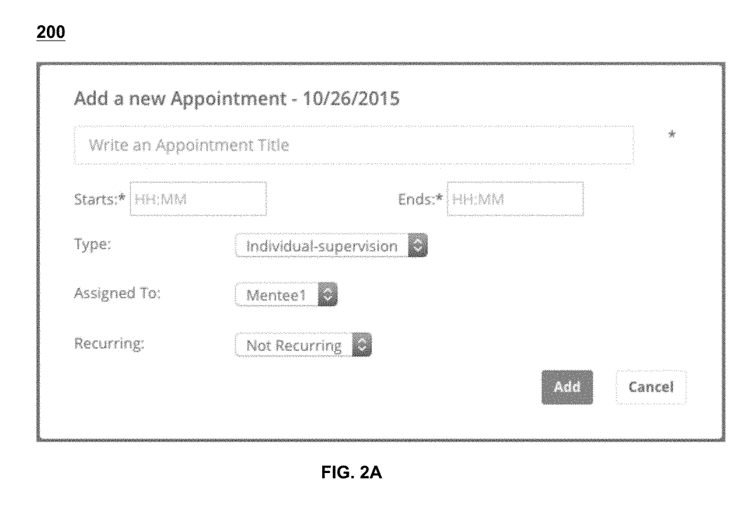

A mentor may access and/or edit a calendar regarding mentorships a mentor is involved with via selection of the calendar option 106, which causes a calendar page and/or window to be provided to a display device for viewing by the mentor. The calendar may display appointments, notifications, and other time-sensitive reminders to a mentor which may, in some instances, be color-coded or otherwise marked to show, for example, priority or a user configured categorization. A mentor may create, edit, and/or delete an appointment via the calendar page. For example, a mentor may make an individual supervision appointment using a set of mentees to choose from. A mentor may also make a group supervision appointment via interface 200 as shown in FIG. 2. Interface 200 may be accessed via the calendar page and may provide the mentor with a text box in which to enter an appointment title, with a text box in which to enter a start time, a text box in which to enter an end time, a drop down menu of appointment type, a drop down menu of mentee groups assigned to the appointment, and a drop down menu indicating whether the appointment is recurring or not. Interface 200 may also include an add button and a cancel button.

The calendar of a mentor may be integrated with a mentorship program and/or requirements thereof for each of the mentees the mentor is mentoring. For example, each type of certification (e.g., BCBA, BCaBA, etc.) may have one or more categories of requirements (e.g., direct hours, indirect hours, individual supervision hours, group supervision hours) that must be met within a defined time period to get the certification. If the amount of hours spent in a supervisory period is not compliant with all the rules of the particular certification, all the hours done in that supervisory period do not count towards total hours required for the certification. In other words, mentee looses all the hours done in that period. Therefore, it is important to both a mentor and the mentee that the hours spent and mentorship and how those hours are spent are accurately recorded and monitored over time.

The following table (Table 1) provides details regarding the program requirements for a BCBA and BCaBA certification at the time of filing the present patent application. A person of skill in the art would understand that, in the event that these requirements change, the values on the following Table 1 may be updated to reflect any and all changes.

TABLE 1

| | | | | | | Minimum number | % of hours | |
|---|---|---|---|---|---|---|---|---|
| | | | | | | of times the | spent that are | |
| | | | | | | supervision | required as | |
| | | Total hours | Maximum | | | is required | supervision | |
| | | required to | duration | | | per each | hours for each | Weekly |
| | | complete | of | Supervisory | | supervisory | supervisory | limit of |
| | Category | the program | program | period | | period | period | hours |
| 1 | BCBA | 1500 | 5 years | 2 | weeks | 1 | 5% | Minimum |
| | Supervised | | | | | | | 10 hrs |
| | Independent | | | | | | | Maximum |
| | Fieldwork | | | | | | | 30 hrs |
| 2 | BCBA | 1000 | 5 years | 1 | week | 1 | 7.5% | Minimum |
| | Practicum | | | | | | | 10 hrs |
| | | | | | | | | Maximum |
| | | | | | | | | 30 hrs |
| 3 | BCBA | 750 | 5 years | 1 | week | 2 | 10% | Minimum |
| | Intensive | | | | | | | 10 hrs |
| | Practicum | | | | | | | Maximum |
| | | | | | | | | 30 hrs |
| 4 | BCaBA | 1000 | 5 years | 2 | weeks | 1 | 5% | Minimum |
| | Supervised | | | | | | | 10 hrs |
| | Independent | | | | | | | Maximum |
| | Fieldwork | | | | | | | 30 hrs |
| 5 | BCaBA | 670 | 5 years | 1 | week | 1 | 7.5% | Minimum |
| | Practicum | | | | | | | 10 hrs |
| | | | | | | | | Maximum |
| | | | | | | | | 30 hrs |
| 6 | BCaBA | 500 | 5 years | 1 | week | 2 | 10% | Minimum |
| | Intensive | | | | | | | 10 hrs |
| | Practicum | | | | | | | Maximum |
| | | | | | | | | 30 hrs |
| 7 | BCaBA | ∞ | ∞ | 1 | month | 1 hr of | 1 hour | NA |
| | Ongoing | | | | | supervision | | |
| | | | | | | (covered in | | |
| | | | | | | one or | | |
| | | | | | | multiple | | |
| | | | | | | appointments) | | |
| 8 | RBT | ∞ | ∞ | 1 | month | 2 (at least | 5% | NA |
| | | | | | | one | | |
| | | | | | | individual | | |
| | | | | | | supervision) | | |

In some embodiments, calendar option 106 may provide a create/delete appointment 122, a meeting page option 124 and an associated mentee task mastery option 126. A meeting page and/or window may be displayed to a mentor upon selection (i.e., clicking) of an appointment, such as a supervision appointment. A mentee task mastery page and/or window may be displayed to mentor upon selection of a mentee profile (e.g., a picture of the mentee, mentee's name).

The meeting page may be used to track supervision meetings with a mentor's mentee(s). A mentor may navigate to a meeting page for any supervision meeting by selecting the scheduled meeting in his or her calendar. The meeting page may show details of the meeting including a written list and/or photograph of people included in the meeting. In some embodiments, when the mentor hovers over a name included in the written list and/or a photograph, information about the individual named or photographed may be provided to the mentor via, for example, a pop up window. In some instances, a mentor may modify the participants for a meeting by adding and/or subtracting mentees via selecting a name on a list and/or a photograph. In this way, the subject matter and/or content of the meeting (e.g., tasks covered, supervision hours, etc.) may not be added to a mentee's records when that mentee did not attend the meeting.

In some embodiments, the meeting page may also provide a task list, which may include a list of tasks to be completed by a mentee and/or group of mentees consistent with the BACB Fourth Edition Task List. In some instances, a mentor's task list may be accessible/viewable by one or more contacts of the mentor. The task list may be organized in, for example, three sections such as basic behavior-analytic skills, client-centered responsibilities, and foundational knowledge. In some instances, a mentor may use a task list to, for example, track or otherwise monitor tasks that have been covered by the mentor and/or accomplished by a mentee or group of mentees.

In some instances, the meeting page may also enable a mentor to track a mentee's progress with regard to one or more tasks on the task list, or otherwise. A mentor may be able to change the status of a task by, for example, indicating that a task is mastered or needs improvement.

A mentor may access and/or edit a contact list via selection of the contacts option 108, which causes a contacts page and/or window 128 to be provided to a display device for viewing by the mentor. The contacts page may enable a mentor to, for example, invite a mentee to be a contact of the mentor 130, receive an invitation to be a contact of another individual, and/or view a profile regarding an individual and/or contact. A mentor may also complete contact information 132 via the contacts page.

A mentor may access and/or edit a goal page regarding mentorships a mentor is involved with via selection of the goals option 110, which causes a goals page and/or window to be provided to a display device for viewing by the mentor. A mentor may be enabled to create and/or edit one or more goals for him or her and/or mentee(s) 134 via the goals page. A mentor may set a timer and/or monitor a set timer for completion of the goal via the goals page. Additionally, deadlines and the status of each goal may be tracked 132 on the goals page via selection of a track assigned goals option.

A mentor may track deadlines and status of each goal for each mentee he or she is mentoring on the goal page. A mentor may also view the name of a mentee to whom the mentor assigned the goal. Once a goal is completed by a mentee, the goals page will indicate same via, for example, a check mark next to the goal or other visual cue.

A mentor may create and/or assign a goal to a particular mentee and/or a group of mentees via selection of the add a goal option. The mentor may also set a deadline for completion of the goal.

A mentor may access and/or edit an assignments page regarding mentorships a mentor is involved with via selection of the assignments option 110, which causes an assignments page and/or window to be provided to a display device for viewing by the mentor. Via the assignments page, a mentor may create, edit, assign, and/or view assignments for mentees and/or tasks due to be completed by a mentee or group of mentees 138 or 140. In some embodiments, the assignments page may display a list of assignments correlated to mentees and deadlines for completion and/or the status of the respective assignments for a mentee or a group of mentees. A mentor may also change the status (e.g., indicate the assignment is complete) via the assignments page.

A mentor may also receive/view assignments completed by mentees via the assignments page and, in some instances, a mentee may receive feedback regarding a particular assignment from the mentor and/or automated feedback (as may be the case with the automatic scoring of a multiple choice test). In some instances, the assignments page may provide the mentee with a list of correct answers for a submitted assignment and may provide feedback to the mentee regarding a particular assignment via the assignments page.

In some embodiments, a mentee may submit an assignment multiple times as may be the case when a mentee retakes a test or quiz. In one embodiment, there are three types of assignments: a multiple-choice quiz assignment, a short answer assignment, and a task assignment. Each of the assignments may be tailored by the mentor by, for example, selecting questions to be included on an assignment or providing instructions and/or requirements for completing the assignment. The assignments page may also provide a way for the mentor to score or grade a completed assignment. For task assignments a mentor designates certain task(s) for a mentee, or group of mentee, to complete over a period of time. At times, a document, an audio, and/or a video file may be attached to an assignment.

A mentor may access a variety of supervision forms via selection of the forms option 114. Files may be added for all of a mentor's mentee 142 and all forms/documents submitted by mentees may be viewed 144. In some instances, supervision forms may be generated for mentees for the respective supervision periods automatically, based on, for example, the appointments scheduled in the calendar.

Initially, a particular mentee may be associated with an experience category that corresponds to the accreditation he or she is attempting to earn. Exemplary mentee experience categories include:

1. BCBA Supervised Independent Fieldwork

2. BCBA Practicum

3. BCBA Intensive Practicum

4. BCaBA Supervised Independent Fieldwork

5. BCaBA Practicum

6. BCaBA Intensive Practicum

7. BCaBA Ongoing

8. RBT

Once a mentee is associated with an experience category, one or more supervision forms may be pre-populated with, for example, mentee information, assignments that are being supervised, requirements for the experience category, etc. In some instances, one or more supervision forms may be automatically generated at the end of the supervision period if at least one individual-supervision has occurred in that period.

In some instances, the supervision forms may pull data directly from the mentee's calendar, mentee's assignments, mentee's goals, etc. Supervision forms may also pull data from the mentor's information such as from the mentor's calendar, assignments, goals, forms, etc.

On some occasions, a form is sent to a mentee for verification. The mentee may then complete and verify his or her part of the form. The mentee may then sign and submits the form. A mentor may also be provided with a list of supervision forms 146 signed and submitted by mentees 148. Once both mentor and mentee sign the form, you will not be able to edit the form but you will be still able to view it along with your signatures and print it.

A mentor may be able to access a supervision form and may be able to verify the correctness of information associated with an accessed form. For example, a mentor may be able to all the mentee-entered hours details, dates, tasks completed during the meeting(s) etc. and then enter an evaluation of supervisee performance. Once done reviewing an accessed form, the mentor may sign the form and submit it.

A mentor may share documents and other files with a mentee and/or group of mentees via a forms page, which is displayed to the mentor when the mentor selects the forms option 114. The mentor may share documents or other files by, for example, uploading and/or providing links to the documents and/or other files. A mentee may also access documents and other files uploaded by a mentee via the forms page.

A mentor may be able to establish, track, and manage all groups that his or her mentees are associated with via selection of the groups menu option 116. For example, a mentor may be able to view all groups with next and previous points 152 or add or edit a group 150.

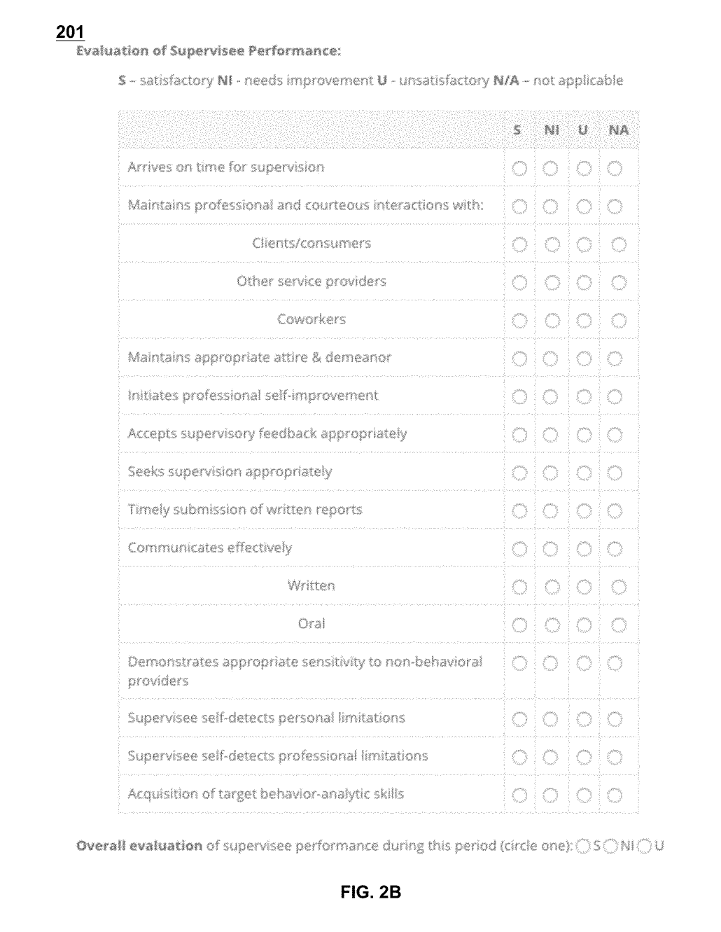

The subject invention may also have a set of features for use by a mentee as illustrated in site map 300 provided in FIG. 3. Sire map 300 provides eight primary menu options for a mentee's use of the mentorship manager application. Each of the menu options of site map 300 relate to mentee menu items, buttons, or options, the selection of which may initiate display of a particular page and/or a window within a page on a display device, such as a desktop computer, a laptop computer, smart phone, and/or tablet computer. The eight primary menu options for mentee site map 300 are mentee profile 302, mentee dashboard 304, mentee calendar 306, mentee contacts 308, mentee goals 310, mentee assignments 312, mentee forms 314, and mentee groups 316.

A mentee may enter profile information (e.g., name, desired certifications, current status within an educational program, location, photograph, etc.) and/or create an account via a page and/or window that displays following selection of mentee profile menu option 302. On some occasions, mentee profile menu option 302 may be accessed via selection (e.g., clicking on) the mentee's user name, which may be displayed below a profile picture of the mentee provided on the page. The mentee may also edit his or her profile and/or account by selection of edit profile information option 323 and/or edit profile picture option 330. In some embodiments, information entered into a mentee's profile page may be viewable by one or more of the mentee's contacts (as managed via the mentee contacts menu 308).

A mentee may access and/or edit a wide range of information about his/her mentorships via selection of the mentee dashboard option 304, which causes a mentee dashboard page and/or window to be provided to a display device for viewing by the mentee. Exemplary information that may be displayed via a dashboard page includes, but is not limited to, information regarding how many hours are being spent by the mentee on mentorships (e.g., via a chart or graph), reminders of appointments or other due dates, reminders, and alerts. Alerts may be categorized according to, for example, time sensitivity and/or priority and this characterization may be manifested in the appearance of the alert of the dashboard screen. For example, highly time sensitive or urgent alerts may be displayed with a red indicator and somewhat less time sensitive or non-urgent alerts may be displayed with a yellow indicator. In some embodiments, red alerts may appear on the mentee dashboard 304 when, for example, a mentee submits a supervision form for a mentor to sign, one of the goals created by the mentee have crossed a deadline and are not yet marked done, and/or an assignment deadline has passed. In some embodiments, yellow alerts may appear on the mentee dashboard 304 as, for example, a reminder for a deadline or when a document or other requirement for a mentee has not been submitted on time.

Notifications may also appear on the mentee dashboard 304 in, for example, a portion of a window (e.g., a corner) displaying the mentee dashboard 304 or other pages as discussed herein. A mentee may interact with a notification by clicking on it so as to, for example, snooze the notification so that it will reappear on the dashboard at a later time and/or when the mentee dashboard 304 is reopened. Notifications may serve to alert a mentee that, for example, an appointment with a mentor has been scheduled, requested, and/or cancelled.

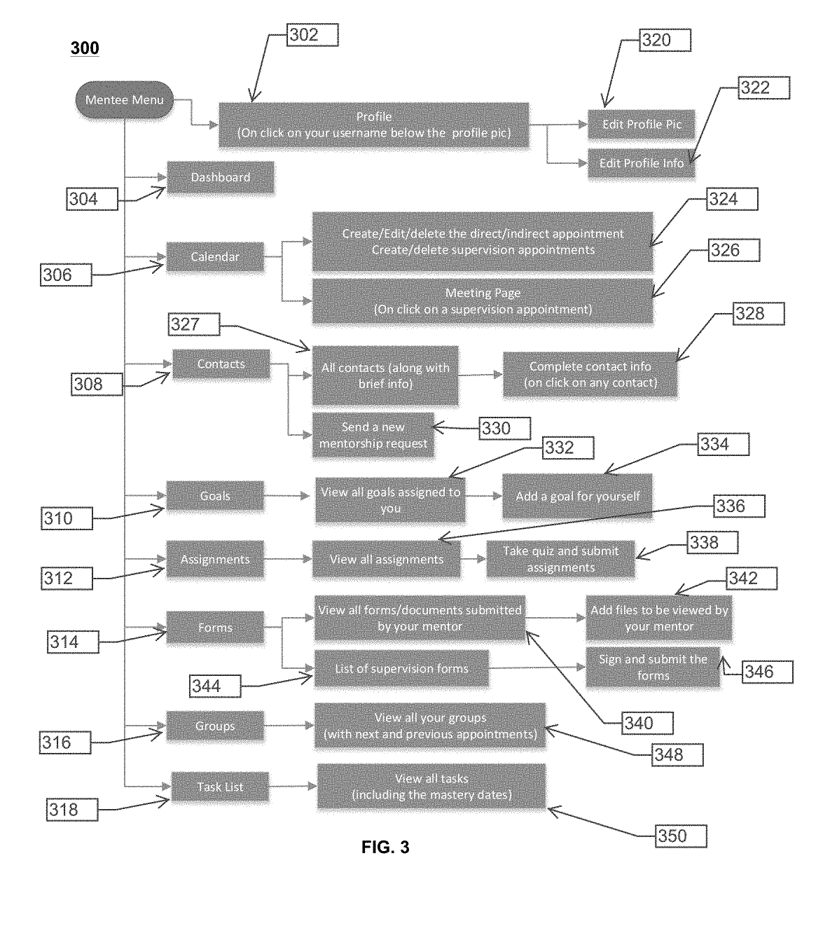

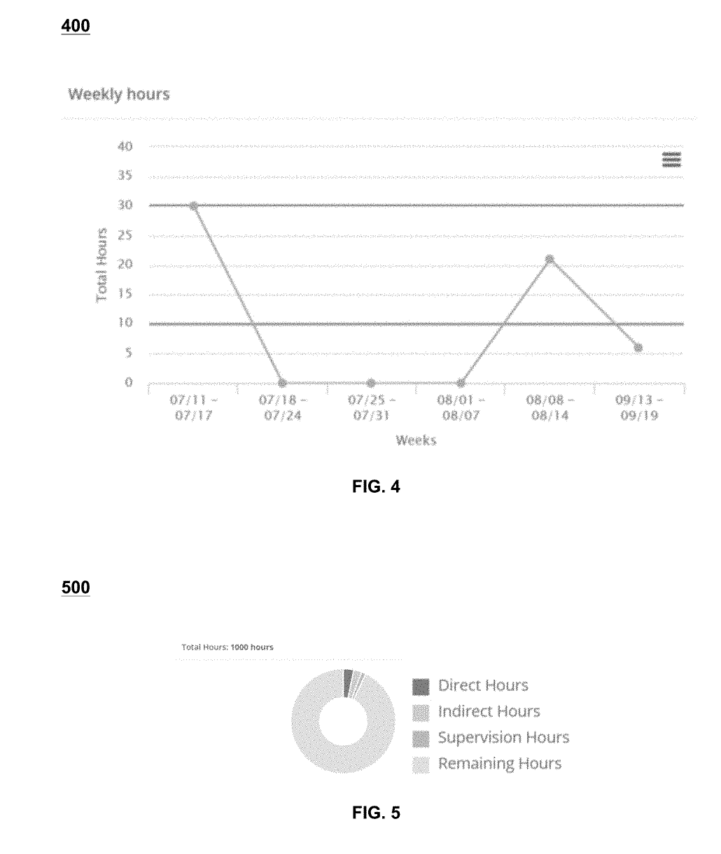

In some embodiments, mentee dashboard 304 may include a weekly hours graph 400, as shown in FIG. 4 and/or a total hours graph 500 as shown in FIG. 5. Weekly hours graph 400 charts out how many hours the mentee has participated in a mentorship and/or mentorship category within a series of weeks or supervisory period. In some embodiments, weekly hours graph 400 may also provide a preferred, or target, range of hours for the mentee to participate in a mentorship within a week.

Total hours graph 500 may show how many hours a mentee has logged over a given time period. At times, the mentee hours may be broken down into various categories (i.e., direct hours, indirect hours, supervision hours, and remaining hours) and displayed as such on total hours graph 500 as shown in the key accompanying the total hours graph 500.

One or more alerts or notifications may also be configured, set, and/or displayed via mentee dashboard 304. In some instances, the alerts may be categorized by priority and/or urgency using, for example, a color-coding system. For example, a red, or high priority alert, may be displayed on mentee dashboard 304 when a supervision form is not signed and submitted within one week of its auto-creation, an assignment is not submitted and its deadline has passed, and/or a goal is not marked as met by the mentor (or by the mentee if the mentee self-created it) and its deadline has passed. Lower priority, or yellow, alerts may be displayed on mentee dashboard 304, for example, a deadline is near. For example, a yellow alert may be displayed two days before an assignment deadline and two weeks before a deadline for a goal the mentee much reach.

Mentee dashboard 304 may also display one or more notifications or other time-sensitive reminders to a mentee which may, in some instances, be color-coded or otherwise marked to show, for example, priority or a mentee configured categorization. At times, the notification may be displayed as a pop-up window or message in a corner of mentee dashboard 304. Notifications may be displayed when, for example, a mentor schedules an individual or group supervision appointment, an appointment is adjusted or cancelled, and a mentorship request is accepted or rejected by a mentor.

A mentee may access and/or edit a calendar regarding mentorships a mentee is involved with via selection of the mentee calendar option 306, which causes a mentee calendar page and/or window to be provided to a display device for viewing by the mentee.

A mentee may create, edit, and/or delete an appointment via the calendar 324. For example, a mentee may make an individual supervision appointment via a meeting page 326.

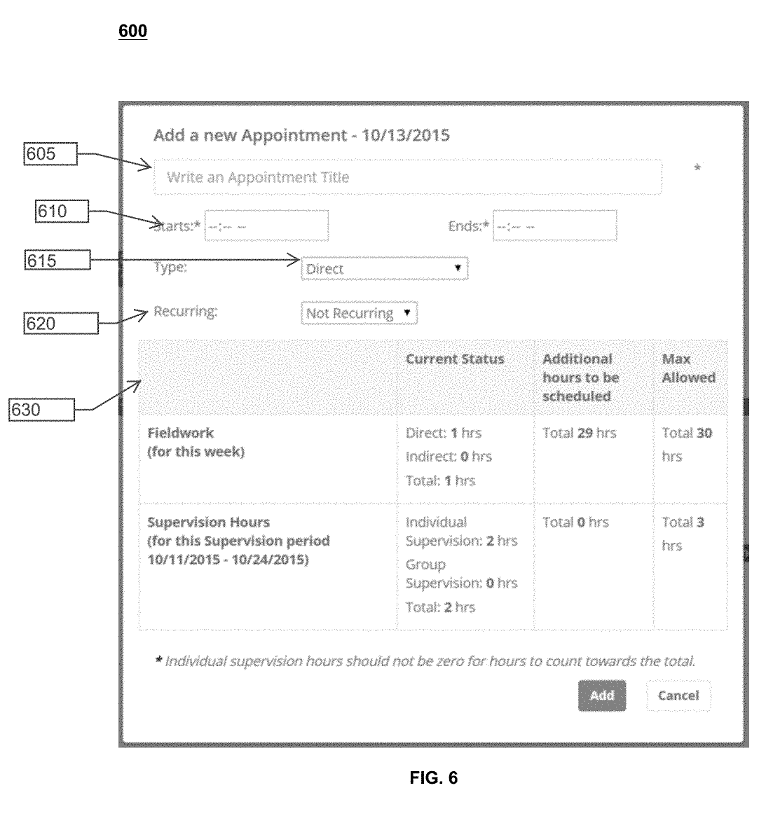

The calendar of a mentee may be integrated with a mentorship program and/or requirements thereof for the mentee as described above with regard to Table 1. In addition, a mentee may add an appointment to his or her calendar via an add a new appointment form 600, an example, of which is provided by FIG. 6. The add a new appointment form 600 of FIG. 6 provides a mentee with fields in which to enter a title 605, start day/time and end day/time 610 and establish whether the appointment is recurring 620. The add a new appointment form 600 also provides a mentee with a drop-down selection menu 615 by which to select the type (e.g., direct hours, indirect hours, supervision hours, or remaining hours) of appointment.

New appointment form 600 also provides a table 630 that lists a category of mentee activity along with current status, additional hours to be scheduled, and maximum allowed hours information. The current status information lists the current status of the mentee for a given category in the form of hours completed. The hours completed for a given category may be provided to the mentee in terms of the types of hours required for and/or associated with the particular category. For example, the fieldwork category of new appointment form 600 provides a total of direct, indirect, and total time completed. Additional hours to be scheduled column shows the number hours the mentee needs to schedule in a given category to meet the requirements of the program they are attempting to complete. The max allowed column shows the maximum total number of hours that can be spent for a given category. Additionally, appointments may be deleted and/or edited via new appointment form 600.

In some embodiments, mentee calendar option 306 may provide a mentee meeting page option 324. A meeting page and/or window may be displayed to a mentee upon selection (i.e., clicking) of an appointment, such as a supervision appointment. A mentee task mastery page and/or window may be displayed to mentee upon selection of a mentee profile (e.g., a picture of the mentee, mentee's name).

The meeting page may be used to track mentorship meetings with a mentee's mentor(s) and/or others that may also be present at a particular meeting or group of meetings. A mentee may navigate to a meeting page for any supervision meeting by selecting the scheduled meeting in his or her calendar. The meeting page may show details of the meeting including a written list and/or photograph of people included in the meeting. In some embodiments, when the mentee hovers over a name included in the written list and/or a photograph, information about the individual named or photographed may be provided to the mentee via, for example, a pop up window. In some instances, a mentee may modify the participants for a meeting by adding and/or subtracting mentees via selecting a name on the list and/or a photograph. In this way, the subject matter and/or content of the meeting (e.g., tasks covered, supervision hours, etc.) will not be added to a mentee's records when that mentee did not attend the meeting.

In some embodiments, the meeting page may also provide a task list, which may include a list of tasks consistent with the BACB Fourth Edition Task List. The task list may be organized in, for example, three sections such as Basic Behavior-Analytic Skills, Client-Centered Responsibilities, and Foundational Knowledge. In some instances, a mentee may use a task list to, for example, track or otherwise monitor tasks that have been completed by the mentee and/or accomplished by the mentee or group of mentees.

In some instances, the meeting page may also enable a mentee to track a mentee's progress with regard to one or more tasks on the task list, or otherwise when, for example, a mentor in charge of the task changes a mentee's status for a particular task or group of tasks. A task list may also provide a mentee with feedback via, for example, a status indicator (e.g., complete, incomplete, needs work, etc.) that may be associated with a task or group of tasks.

A mentee may access and/or edit a contact list via selection of the mentee contacts option 308, which causes a contacts page and/or window to be provided to a display device for viewing by the mentor 327, 328. The contacts page may enable a mentee to, for example, invite a mentor, or potential mentor, to be a contact of the mentee, receive an invitation to be a contact of another individual, and/or view a profile regarding an individual and/or contact 330. Once a mentor is added as a contact, a profile of the mentor may be provided (e.g., following selection of a link or icon) to the mentee.

A mentee may view and/or access details regarding one or more mentorship goals on a goal page via selection of the mentee goals option 310, which causes a goals page and/or window to be provided to a display device for viewing by the mentee. Details regarding a goal, task, and/or assignment, such as deadlines or status of each goal, a name of a mentor/person who assigned the goal, task, and/or assignment may be provided via the goal page 332. A mentee may also be able to create and/or edit one or more goals for himself or herself via the goal page 334.

A mentee may access an assignments page regarding mentorships a mentee is involved with via selection of the mentee assignments option 310, which may cause a mentee's assignments page and/or window to be provided to a display device for viewing by the mentee 336. Via the assignments page, a mentee may view assignments and/or tasks due to be completed by the mentee or group to which the mentee is a member 338. In some embodiments, the assignments page may display a list of assignments correlated to, for example, mentors, deadlines for completion, and/or the status of the respective assignments. On some occasions, a mentee may change the status of an assignment (e.g., indicate the assignment is complete) via the assignments page.

A mentee may also receive/view assignments assigned by a mentor via the assignments page. A mentee may also access, edit, work on, and/or submit an assignment via the assignments page. At times, a document, an audio, and/or a video file may be attached to an assignment via the assignments page. In some circumstances, a mentee may receive feedback regarding a particular assignment from the mentor and/or automated feedback (as may be the case with the automatic scoring of a multiple choice test). In some instances, the assignments page may provide the mentee with a list of correct answers for a submitted assignment. In some circumstances, a mentee may submit an assignment multiple times as may be the case when a mentee retakes a test or quiz.

In one embodiment, there are three types of assignments: a multiple-choice quiz assignment, a short answer assignment, and a task assignment. A mentor may tailor each of the assignments by, for example, selecting questions to be included on an assignment and/or providing instructions and/or requirements for completing the assignment. A multiple choice quiz assignment may include a list of questions with a number of options for answering the question, one of which is correct. In most cases, a mentee may take/complete the multiple choice quiz via the assignments page.

A short answer assignment may include a list of questions to be answered with short (e.g., 4-10 sentences) answers. A task assignment is more descriptive in nature and may require a mentee to perform certain tasks. A mentee may demonstrate partial or whole completion of a task by, for example, entering text or by attaching a document to the task and/or assignments page.

A mentee may access a variety of supervision forms 344 via selection of the mentee forms option 314, which may cause a supervision form page to be provided to a mentee via a supervision form page 340. In some instances, supervision forms may generated for mentees for the respective supervision periods automatically, based on, for example, goals, tasks, and/or the appointments assigned to him or her and/or scheduled in their calendar 342. In some embodiments, a mentee may sign and submit a form 346.

Initially, a particular mentee may be associated with an experience category that corresponds to the accreditation he or she is attempting to earn and/or level of completion of the accreditation process. Exemplary mentee accreditation, or experience, categories include:

### 1) BCBA Supervised Independent Fieldwork

### 2) BCBA Practicum

### 3) BCBA Intensive Practicum

### 4) BCaBA Supervised Independent Fieldwork

### 5) BCaBA Practicum

### 6) BCaBA Intensive Practicum

### 7) BCaBA Ongoing

### 8) RBT

Once a mentee is associated with an experience category, one or more supervision forms may be pre-populated with, for example, mentee information, assignments that are being supervised, requirements for the experience category, etc. In some instances, one or more supervision forms may be automatically generated at the end of the supervision period if at least one individual-supervision has occurred in that period.

In some instances, the supervision forms may pull data directly from the mentee's calendar, mentee's assignments, mentee's tasks, mentee's goals, etc. Supervision forms may also pull data from the mentor's information such as from the mentor's calendar, assignments, goals, forms, etc. Additionally, or alternatively, a supervision form may be automatically generated at, for example, an end of the supervision period when at least one individual-supervision has occurred in that period. In these instances, a supervision form may be generated by using/pulling data directly from the mentee's calendar. A mentee may also be able to view a list of previously generated supervision forms via the supervision form page.

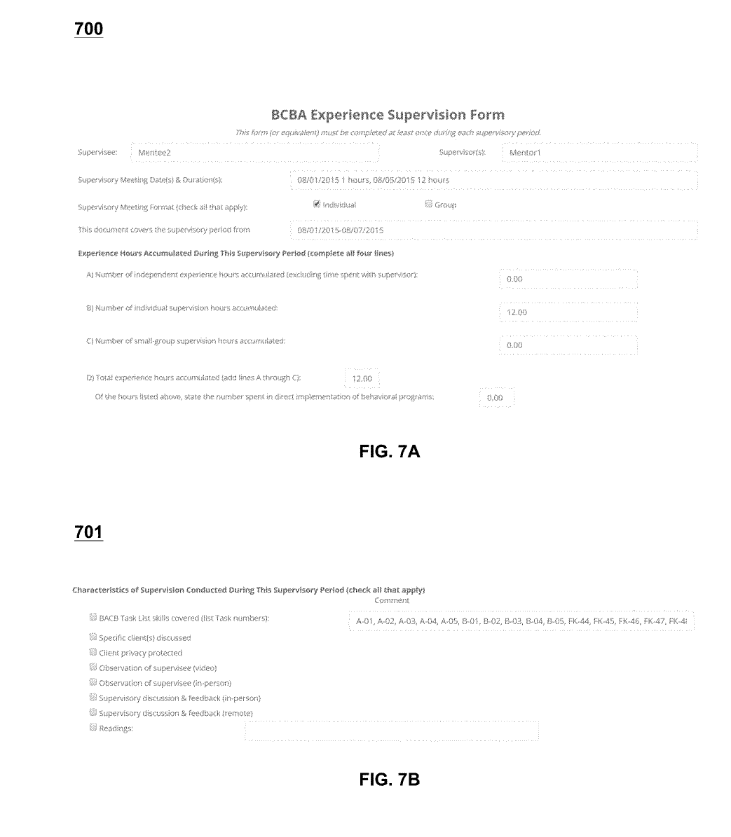

Exemplary supervision forms that may be accessed by a mentee via the supervision form page are provided in FIGS. 7A and 7B. More specifically, FIG. 7A provides an exemplary BCBA experience supervision form 700, which is specifically tailored to the individual mentee using, for example, historical information regarding the accomplishments of the mentee, calendar information, meeting information (e.g., dates, duration, subject matter).

BCBA experience supervision form 700 may be designed to capture and/or track information (e.g., mentee performance, task completion, etc.) specific to the BCBA accreditation process/program. For example, BCBA experience supervision form 700 may indicate a format (e.g., individual, group, etc.) for a supervisory meeting and a number of mentorship hours accumulated by the mentee during a supervisory period.

FIG. 7B provides a characteristics of supervision conducted form 701, which indicates a number of characteristics that may be associated with, for example, the supervisory period, mentee, and/or accreditation program.

Once complete, a mentee may submit BCBA experience supervision form 700 and/or characteristics of supervision conducted form 701 to a mentor for his or her comment, review, approval, etc.

Selection of mentee forms option 314 may provide a mentee with a page or other interface whereby a mentee may communicate with and share supervision forms and other documents with a mentor. Additionally, a mentee may upload files, such as forms, documents, scanned documents, pictures, and completed assignments on this page.

Selection of mentee group option 316 may provide a mentee with a page or other interface whereby a mentee may establish, edit, and/or communicate with members of a group via a groups page 348. The groups page may also provide the mentee with information about group members (e.g., picture, interests, location) and may enable a mentee to access information regarding group meetings and associated collateral material (e.g., agendas or documents for discussion).

Selection of mentee tasks option 318 may provide a mentee with a page or other interface whereby a mentee may establish, edit, and/or access one or more tasks 350.

We claim:

1. A method comprising:
receiving, by a processor, selection of at least one of a board certified behavior analyst (BCBA) and a board certified assistant behavior analyst (BCaBA) accreditation type from a mentee;
establishing, by the processor, a set of mentorship goals and tasks to be completed by the mentee, the mentorship goals and tasks being compliant with at least one of a BCBA accreditation program and a BCaBA accreditation program. Each of the mentorship goals and tasks are associated with a set of completion criteria and a mastery date. receiving, by the processor, an assignment from a mentor;
determining, by the processor, how the assignment is associated with the mentorship goals and tasks and associated sets of completion criteria;
providing, by the processor, the assignment to the mentee;
receiving, by the processor, an indication that the mentee completed an assignment;
updating, by the processor, the set of mentorship goals and tasks and associated sets of completion criteria to reflect the completed assignment; and
providing, by the processor, the updated set of mentorship goals and tasks and associated sets of completion criteria to the mentee.

2. The method of claim 1, further comprising:
receiving information regarding one or more contacts for the mentee; and
providing information regarding the contact to the mentee via a contacts page displayed to the mentee by a display device.

3. The method of claim 1, further comprising:
providing, by the processor, a calendar to the mentee, the calendar including one or more appointments associated with a date on the calendar, wherein the appointment relates to at least one of the goals.

4. The method of claim 1, further comprising:
providing, by the processor, one or more status indicators to the mentee.

5. The method of claim 1, further comprising:
generating, by the processor, a personalized supervision form for the mentee, the personalized supervision form including information regarding a completion status of the mentee with regard to the set of mentorship goals and tasks and associated sets of completion criteria.

6. The method of claim 1, wherein the accreditation program incorporates a BCBA Fourth Edition Task List.

7. The method of claim 1, wherein each of mentorship goals and tasks are associated with at least one of basic behavior-analytic skills, client-centered responsibilities, and foundational knowledge.

8. A method comprising:
receiving, by a processor, information regarding a plurality of mentees to be supervised by a mentor as the mentees progress through at least one of a board certified behavior analyst (BCBA) and a board certified assistant behavior analyst (BCaBA) accreditation type;
establishing, by the processor, a set of mentorship goals and tasks to be completed for each of the mentees, the mentorship goals and tasks being compliant with a BCBA accreditation program, wherein each of mentorship goals and tasks are associated with a set of completion criteria and a mastery date;
receiving, by the processor, a set of criteria for an assignment to be completed by at least one of the mentees from the mentor;
determining, by the processor, how the assignment is associated with the mentorship goals and tasks and associated sets of completion criteria for the at least one mentee;
receiving, by the processor, an indication that the mentee completed an assignment;
updating, by the processor, the set of mentorship goals and tasks and associated sets of completion criteria to reflect the completed assignment; and
providing, by the processor, the updated set of mentorship goals and tasks and associated sets of completion criteria to the mentee.

9. The method of claim 8, further comprising:
receiving information regarding one or more contacts for the mentor; and
providing information regarding the contact to the mentor via a contacts page displayed to the mentor by a display device.

10. The method of claim 8, further comprising:
providing, by the processor, a calendar to the mentor, the calendar including one or more appointments associated with a date on the calendar, wherein the appointment relates to at least one of the goals.

11. The method of claim 8, further comprising:
providing, by the processor, one or more status indicators to the mentor.

12. The method of claim 8, further comprising:
generating, by the processor, a personalized supervision form for each mentee of the plurality of mentees, the personalized supervision form including information regarding a completion status of the mentee with regard to the set of mentorship goals and tasks and associated sets of completion criteria.

13. The method of claim 8, wherein the accreditation program incorporates a BCBA Fourth Edition Task List.

14. The method of claim 8, further comprising:
receiving, by the processor, a request for a meeting from one of the plurality of mentees; and
adding the requested meeting to a calendar for the mentor.

15. The method of claim 8, further comprising:
simultaneously tracking, by the processor, the rate of completion of the set of mentorship goals and tasks for each of the mentees of the plurality of mentees; and
providing, by the processor, feedback to the mentor regarding the rate of completion for each of the mentees of the plurality of mentees.
